(19) United States
(12) Patent Application Publication
(10) Pub. No.: US 2024/0331570 A1
(43) Pub. Date: Oct. 3, 2024

(54) TISSUE DISTENSION MODEL

(71) Applicant: KCI Manufacturing Unlimited Company, Westmeath (IE)

(72) Inventors: Christopher J. CARROLL, San Antonio, TX (US); Jonathan G. REHBEIN, San Antonio, TX (US); Richard M. KAZALA, San Antonio, TX (US); Larry Tab RANDOLPH, San Antonio, TX (US); Benjamin A. PRATT, Poole (GB); Colin J. HALL, Poole (GB)

(21) Appl. No.: 18/693,734

(22) PCT Filed: Aug. 23, 2022
(86) PCT No.: PCT/IB2022/057874

§ 371 Date: Mar. 20, 2024

Related U.S. Application Data
(60) Provisional application No. 63/247,614, filed on Sep. 23, 2021.

(51) Int. Cl. G09B 23/30

(52) U.S. Cl. CPC G09B 23/30

(57) ABSTRACT

A test model may include a chamber, a tissue simulation material, and a visual indicator. The chamber may include a base, a lid, and an interior volume defined between the base and the lid. The tissue simulation material may be disposed within the interior volume of the chamber. The tissue simulation material may include a first surface and a second surface. The tissue simulation material may be configured to deform when the second surface is exposed to a lower pressure than the first surface in the interior volume of the chamber. The visual indicator may be configured to provide a visual state change in response to deformation of the tissue simulation material.

### CROSS-REFERENCE TO RELATED APPLICATIONS

This application is a U.S. National Stage Entry of PCT/IB2022/057874, filed Aug. 23, 2022, which claims the benefit, under 35 U.S.C. § 119(e), of U.S. Provisional Patent Application No. 63/247,614, entitled “TISSUE DISTENSION MODEL,” filed Sep. 23, 2021, each of which are incorporated herein by reference for all purposes.

### TECHNICAL FIELD

The invention set forth in the appended claims relates generally to models used to demonstrate tissue distension and more particularly, but without limitation, to a test model to demonstrate tissue distension as an effect of the application of circumferential negative pressure.

### BACKGROUND

Clinical studies and practice have shown that reducing pressure in proximity to a tissue site can augment and accelerate growth of new tissue at the tissue site. The applications of this phenomenon are numerous, but it has proven particularly advantageous for treating wounds. Regardless of the etiology of a wound, whether trauma, surgery, or another cause, proper care of the wound is important to the outcome. Treatment of wounds or other tissue with reduced pressure may be commonly referred to as “negative-pressure therapy,” but is also known by other names, including “negative-pressure wound therapy,” “reduced-pressure therapy,” “vacuum therapy,” “vacuum-assisted closure,” and “topical negative-pressure,” for example. Negative-pressure therapy may provide a number of benefits, including migration of epithelial and subcutaneous tissues, improved blood flow, and micro-deformation of tissue at a wound site. Together, these benefits can increase development of granulation tissue and reduce healing times.

While the clinical benefits of negative-pressure therapy are widely known, it is difficult to demonstrate the impact that negative-pressure therapy has on a tissue site. A test model to show the effect that the application of circumferential negative pressure has on a tissue site may benefit healthcare providers and patients.

### BRIEF SUMMARY

New and useful systems, apparatuses, and methods for demonstrating tissue distension as an effect of the application of circumferential negative pressure are set forth in the appended claims. Illustrative embodiments are also provided to enable a person skilled in the art to make and use the claimed subject matter.

For example, in some embodiments, a test model is described. The test model can include a chamber, a tissue simulation material, and a visual indicator. The chamber can include a base, a lid, and an interior volume defined between the base and the lid. The tissue simulation material can be disposed within the interior volume of the chamber. The tissue simulation material can include a first surface and a second surface opposite the first surface. The tissue simulation material can be configured to deform when the second surface is exposed to a lower pressure than the first surface in the interior volume of the chamber. The visual indicator can be configured to provide a visual state change in response to deformation of the tissue simulation material.

The tissue simulation material can be positioned between a first portion of the interior volume of the chamber and a second portion of the interior volume of the chamber. The first surface of the tissue simulation material can be exposed to the first portion of the interior volume of the chamber and the second surface of the tissue simulation material can be exposed to the second portion of the interior volume of the chamber. The first portion of the interior volume of the chamber can be fluidly isolated from the second portion of the interior volume of the chamber.

The second portion of the interior volume of the chamber can extend from the base to the lid and can surround the first portion of the interior volume of the chamber. In some examples, the test model can further include a chamber seal that can extend from the first surface of the tissue simulation material to the lid of the chamber. The chamber seal can fluidly seal the first portion of the interior volume from the second portion of the interior volume within the chamber. The first portion of the interior volume can be defined between the first surface of the tissue simulation material and the lid of the chamber.

The example test model can further include a reduced-pressure port in the chamber. The reduced-pressure port can fluidly couple the second portion of the interior volume of the chamber to a reduced-pressure source. The test model can also include an atmospheric port. The atmospheric port can allow fluid communication between the first portion of the interior volume of the chamber and ambient environment pressure.

In some examples, the visual indicator can provide the visual state change in response to the second surface of the tissue simulation material being exposed to the lower pressure. The visual state change can be a change in size, shape, position, or color, for example. In some examples, the visual indicator can be at least one circle cast into the tissue simulation material or at least one circle etched into the lid of the chamber. In other examples, the visual indicator can be at least one slit or at least one hole in the tissue simulation material. In other examples, the visual indicator can be at least one fiber embedded into the tissue simulation material or at least one colored area of the tissue simulation material.

Illustrative example embodiments of a method of demonstrating tissue distension are also described herein. In some examples, the method can include providing a chamber that can include a base, a lid, and an interior volume defined between the base and the lid. The method can further include disposing a tissue simulation material within the interior volume of the chamber. The tissue simulation material can include a first surface and a second surface positioned opposite the first surface. The tissue simulation material can be configured to deform when the second surface is exposed to a lower pressure than the first surface in the interior volume of the chamber.

In some examples, the method can include coupling a reduced-pressure port of the chamber to a reduced-pressure source, and activating the reduced-pressure source to expose the second surface of the tissue simulation material to a lower pressure than the first surface within the interior volume of the chamber. Further, the method can include visually perceiving a visual indicator configured to provide a visual state change in response to deformation of the tissue simulation material.

Other example embodiments may describe another method of demonstrating tissue distension. In other embodiments, the method may include providing a chamber that can include an interior volume and a tissue simulation material disposed within the interior volume. Further, the method may include exposing a first surface of the tissue simulation material to atmospheric pressure and a second surface of the tissue simulation material to a reduced-pressure. Further, the method may include visually perceiving a visual state change when the second surface is exposed to the reduced-pressure.

Objectives, advantages, and a preferred mode of making and using the claimed subject matter may be understood best by reference to the accompanying drawings in conjunction with the following detailed description of illustrative embodiments.

### BRIEF DESCRIPTION OF THE DRAWINGS

FIG. 1 is a perspective view of an illustrative example embodiment of a test model for demonstrating tissue distension;

FIG. 2 is an exploded view of the test model of FIG. 1;

FIG. 3 is a cut-away view of an illustrative example embodiment of the test model of FIG. 1;

FIG. 4A illustrates an example embodiment of a tissue simulation material in a resting state free of exposure to reduced-pressure;

FIG. 4B illustrates an example embodiment of the tissue simulation material of FIG. 4A in a deformed state during exposure to reduced-pressure;

FIG. 5A illustrates another example embodiment of a tissue simulation material in a resting state free of exposure to reduced-pressure;

FIG. 5B illustrates another example embodiment of the tissue simulation material of FIG. 5A in a deformed state during exposure to reduced-pressure;

FIG. 6 is a cut-away view of another illustrative example embodiment of a test model for demonstrating tissue distension;

FIG. 7 is a perspective view of an illustrative example embodiment of a system for demonstrating tissue distention; and

FIG. 8 is a block diagram of a method of demonstrating tissue distension, according to an exemplary embodiment.

### DESCRIPTION OF EXAMPLE EMBODIMENTS

The following description of example embodiments provides information that enables a person skilled in the art to make and use the subject matter set forth in the appended claims, but it may omit certain details already well-known in the art. The following detailed description is, therefore, to be taken as illustrative and not limiting.

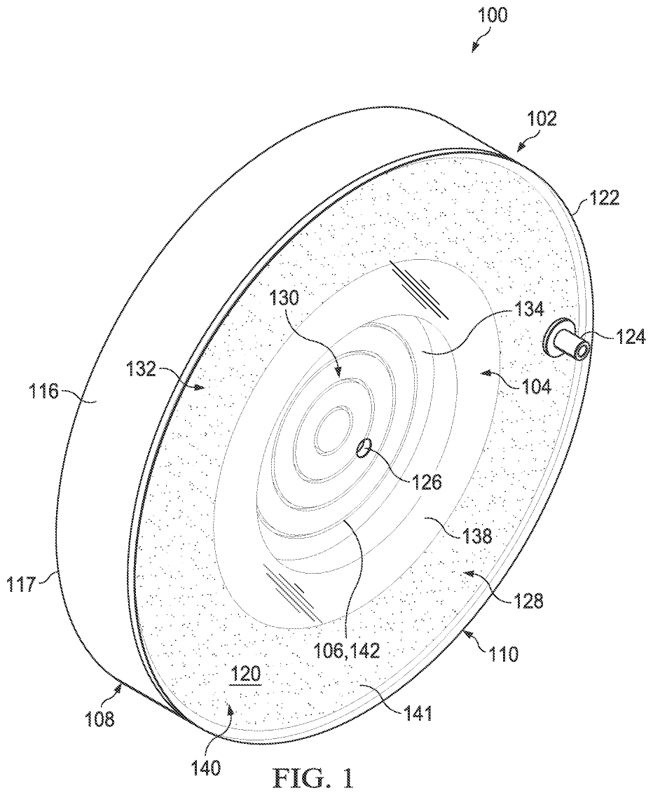

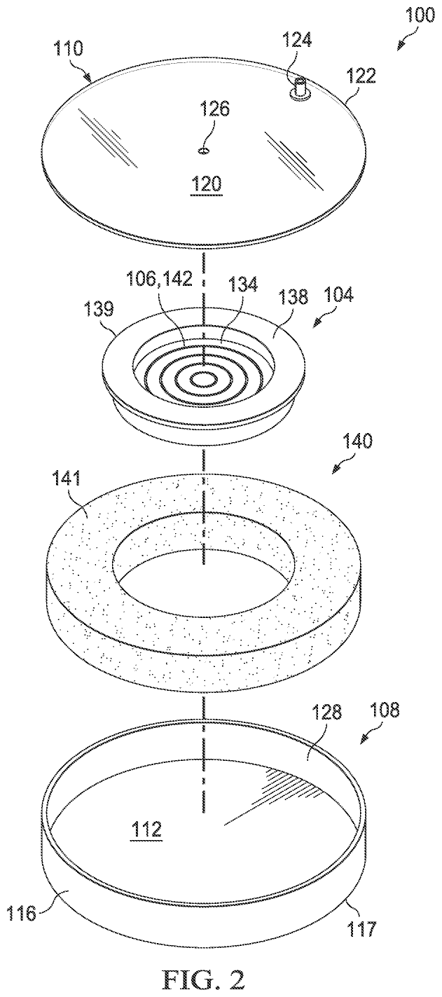

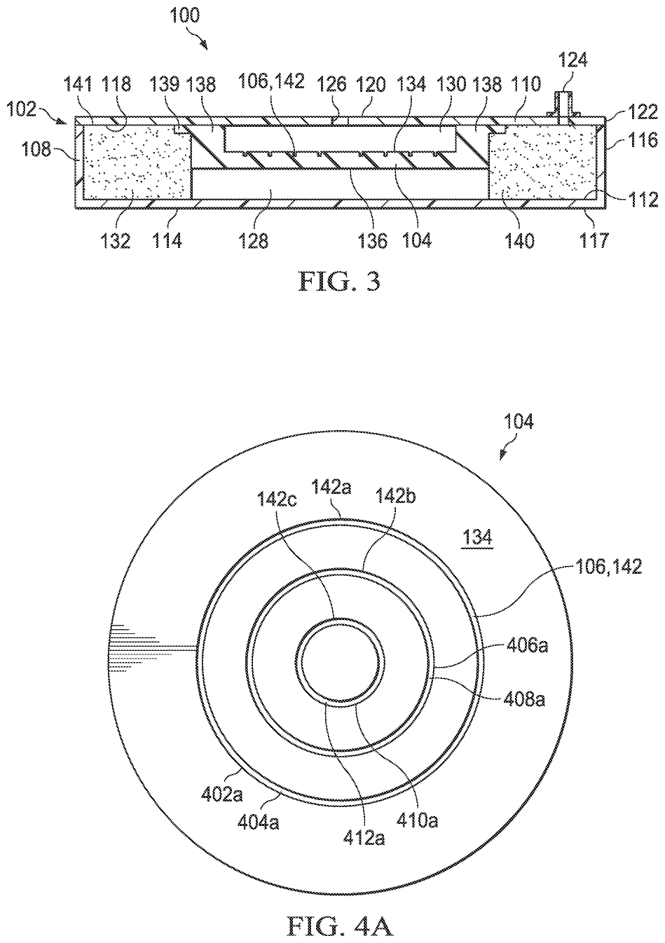

Referring to the drawings, FIGS. 1-3 depict an example embodiment of a test model 100 for demonstrating tissue distension. The test model 100 may include a chamber 102, a tissue simulation material 104 and a visual indicator 106. The chamber 102 may include a base 108 and a lid 110. In some embodiments, the base 108 may be circular. In other embodiments, the base 108 may be rectangular, square, or another shape. The base 108 may have an interior surface 112. The base 108 may have an exterior surface 114 opposite the interior surface 112. A wall 116 may extend from a periphery 117 of the interior surface 112 of the base 108 away from the exterior surface 114 of the base 108.

The lid 110 may be circular and may be substantially the same shape as the interior surface 112 of the base 108. The lid 110 may have an interior surface 118 and an exterior surface 120 opposite the interior surface 118. The interior surface 118 may face the interior surface 112 of the base 108 when the lid 110 is coupled to the base 108. The lid 110 may have a periphery 122. There may be a reduced-pressure port 124 disposed through the lid 110 of the chamber 102. The reduced-pressure port 124 may be located proximate to the periphery 122 of the lid 110. In other embodiments, the reduced-pressure port 124 may be located at a different location of the chamber 102. For example, in some embodiments, the reduced-pressure port 124 may be disposed through the wall 116 of the base 108. In some embodiments, there may be an atmospheric port 126 disposed through the lid 110 of the chamber 102. The atmospheric port 126 may be located proximate to a center of the lid 110. The atmospheric port 126 may allow air to enter a portion of the chamber 102 and help reduce any internal tension that may be associated with the tissue simulation material 104 within the chamber 102.

The interior surface 118 along the periphery 122 of the lid 110 may couple to the wall 116 of the base 108 to create the chamber 102. The lid 110 may be coupled to the base 108 by a weld, adhesives, or any other suitable means of coupling to create a fluid seal between the base 108 and the lid 110. When the lid 110 is coupled to the base 108, there may be an interior volume 128 defined between the base 108 and the lid 110 of the chamber 102. The interior volume 128 of the chamber 102 may have a first portion 130 and a second portion 132. The second portion 132 of the interior volume 128 of the chamber 102 may extend from the base 108 to the lid 110. The second portion 132 of the interior volume 128 may circumferentially surround the first portion 130 of the interior volume 128 of the chamber 102 such that the first portion 130 of the interior volume 128 may be confined to a center of the interior volume 128 of the chamber 102.

The base 108 of the chamber 102 may be formed from a transparent material. The transparent material may have sufficient rigidity and structural integrity to withstand the application of a reduced-pressure and to contain fluids therein. In some embodiments, the base 108 of the chamber 102 may be comprised of glass. In other embodiments, the base 108 of the chamber 102 may be comprised of other exemplary materials such as plastics, polymers, thermoplastics, metals, metal alloys, composition material, fiber-type materials, and other similar materials. The plastics described herein may be a substance or structure capable of being shaped or molded with or without the application of heat, a high polymer, usually synthetic, combined with other ingredients such as curatives, fillers, reinforcing agents, plasticizers, etc. Plastics can be formed or molded under heat and pressure in its raw state and machined to high dimensional accuracy, trimmed and finished in its hardened state. The thermoplastic type can be resoftened to its original condition by heat. In addition, the plastics may mean engineered plastics such as those that are capable of sustaining high levels of stress and are machinable and dimensionally stable. Some exemplary plastics are nylon, acetyls, polycarbonates, ABS resins, PPO/styrene, ISOPLAST 2530, TURLUX HS 2822, and polybutylene terephthalate.

The lid 110 of the chamber 102 may be formed from a transparent material that can couple to the base 108 of the chamber 102. In some embodiments, the lid 110 of the chamber 102 may be comprised of any of the materials listed above for the base 108 of the chamber 102. For example, in some embodiments, the lid 110 may comprise one or more of the following materials: hydrophilic polyurethane; cellulosics; hydrophilic polyamides; polyvinyl alcohol; polyvinyl pyrrolidone; hydrophilic acrylics; hydrophilic silicone elastomers; an INSPIRE 2301 material from Expopack Advanced Coatings of Wrexham, United Kingdom having, for example, an MVTR (inverted cup technique) of 14400 g/m²/24 hours and a thickness of about 30 microns; a thin, uncoated polymer drape; natural rubbers; polyisoprene; styrene butadiene rubber; chloroprene rubber; polybutadiene; nitrile rubber; butyl rubber; ethylene propylene rubber; ethylene propylene diene monomer; chlorosulfonated polyethylene; polysulfide rubber; polyurethane (PU); EVA film; co-polyester; silicones; a silicone drape; a 3M Tegaderm® drape; a polyurethane (PU) drape such as one available from Avery Dennison Corporation of Pasadena, California; polyether block polyamide copolymer (PEBAX), for example, from Arkema, France; Expopack 2327; or other appropriate material.

The tissue simulation material 104 may be disposed within the interior volume 128 of the chamber 102. The tissue simulation material 104 may have a first surface 134 and a second surface 136 opposite the first surface 134. The tissue simulation material 104 may be configured to deform when the second surface 136 is exposed to a lower pressure than the first surface 134 in the interior volume 128 of the chamber 102.

The tissue simulation material 104 may be disposed between the first portion 130 of the interior volume 128 of the chamber 102 and the second portion 132 of the interior volume 128 of the chamber 102. More specifically, the first surface 134 of the tissue simulation material 104 may be exposed to the first portion 130 of the interior volume 128 of the chamber 102 and the second surface 136 of the tissue simulation material 104 may be exposed to the second portion 132 of the interior volume 128 of the chamber 102. The reduced-pressure port 124 may be configured to fluidly couple the second portion 132 of the interior volume 128 of the chamber 102 and the second surface 136 of the tissue simulation material 104 to a reduced-pressure source. The atmospheric port 126 may be configured to fluidly couple the first portion 130 of the interior volume 128 of the chamber 102 and the first surface 134 of the tissue simulation material 104 to ambient atmospheric pressure. In some embodiments, the tissue simulation material 104 may have a spacer or a skirt extending from the second surface 136 to the interior surface 112 of the base 108. The spacer or skirt may be configured to enable the tissue simulation material 104 to remain in place during the application of reduced-pressure to the chamber 102 and to allow the second surface 136 of the tissue simulation material 104 to be in fluid communication with the second portion 132 of the interior volume 128.

In some embodiments, the test model 100 may further include a chamber seal 138. The chamber seal 138 may extend from the first surface 134 of the tissue simulation material 104 to the interior surface 118 of the lid 110 of the chamber 102. In some embodiments, the chamber seal 138 may be formed integrally with the tissue simulation material 104. In other embodiments, the chamber seal 138 may be coupled to the first surface 134 of the tissue simulation material 104. The chamber seal 138 may be coupled to the tissue simulation material 104 in any suitable manner, such as, by a weld or an adhesive. The first portion 130 of the interior volume 128 may be defined between the first surface 134 of the tissue simulation material 104, the lid 110, and the chamber seal 138 such that the first portion 130 of the interior volume 128 of the chamber 102 is fluidly isolated from the second portion 132 of the interior volume 128 of the chamber 102. In some embodiments, the chamber seal 138 may be coupled to the interior surface 118 of the lid 110 to ensure that the first portion 130 of the interior volume 128 remains fluidly isolated from the second portion 132 of the interior volume 128. The chamber seal 138 may be coupled to the interior surface 118 of the lid 110 by any suitable manner, such as, by a weld, or an adhesive.

In some example embodiments, the tissue simulation material 104 may be representative in size of a human limb. For example, in some embodiments, the tissue simulation material 104 may be between 3 inches and 8 inches in diameter. In some preferred embodiments, the tissue simulation material 104 may be about 5 inches in diameter.

The tissue simulation material 104 and the chamber seal 138 may be gas impermeable and elastic. In some embodiments, the tissue simulation material 104 may be a silicone disk. The silicone disk may be formed from a soft cast silicone material. The silicone disk may have a durometer of between about Shore 00-00 and Shore 00-20. In some preferred embodiments, the silicone disk may have a durometer of about Shore 00-10. The soft cast silicone material may have a similar elasticity to human tissue which may result in a more life-like model in order to demonstrate tissue distension. The silicone material may be cast or otherwise formed using a mixture of cured silicone and prosthetic deadener. The cured silicone may be, for example Mouldlife Siliglass or another commercially available Siliglass product. The deadener may be, for example, Mouldlife Smiths Prosthetic Deadener or another commercially available silicone deadener product. Among other benefits, the silicone deadener reduces the synthetic feel of the silicone in order to better simulate the properties of human tissue. The mixture ratio of the cured silicone and prosthetic deadener may vary depending on the desired material properties. According to an exemplary embodiment, a mixture ratio of siliglass to prosthetic deadener is approximately 1 to 6 (e.g., 1 part siliglass to 6 parts prosthetic deadener, 600% prosthetic deadener, etc.). In other embodiments, the tissue simulation material 104 may be or may include a flexible membrane, such as, for example, a polymer film or a balloon. In some examples, the chamber seal 138 may be formed from a silicone of higher durometer than the silicone disk. The chamber seal 138 may be formed of a silicone of a durometer of between about Shore A-00 and Shore A-20. In some preferred embodiments, the chamber seal 138, may be comprised of a silicone with a durometer of about Shore A-12.

In some embodiments, the test model 100 may further include an optional foam 140 disposed within the interior volume 128. More specifically, the optional foam 140 may be disposed within the second portion 132 of the interior volume 128 of the chamber 102. The optional foam 140 may be configured to circumferentially surround the tissue simulation material 104. In some embodiments, the chamber seal 138 may have an extension or a lip 139 that may rest on a first surface 141 of the optional foam 140. The lip 139 may help to hold the tissue simulation material 104 in place to maintain the fluid seal between the first portion 130 of the interior volume 128 and the second portion 132 of the interior volume 128. In some embodiments, the optional foam 140 may be a foam ring or donut. In other embodiments, the optional foam 140 may be a rectangular piece of foam bent into a circular shape to fit into the base 108 of the chamber 102 and to surround the tissue simulation material 104. The optional foam 140 may help observers visually perceive when the second portion 132 of the interior volume 128 of the chamber 102 is exposed to a reduced-pressure. For example, observers may visually perceive the optional foam 140 deforming from its original resting state when reduced-pressure is applied to the second portion 132 of the interior volume 128 of the chamber 102.

The optional foam 140 may have a plurality of interconnected flow channels and may be, for example, cellular foam, open-cell foam, reticulated foam, porous tissue collections, and other porous materials that generally include pores, edges, and/or walls adapted to form interconnected fluid pathways. In some illustrative embodiments, the optional foam 140 may be a porous foam material having interconnected cells or pores adapted to uniformly (or quasi-uniformly) distribute fluid throughout the foam. The foam material may be either hydrophobic or hydrophilic. In one non-limiting example, the optional foam 140 may be an open-cell, reticulated polyurethane foam such as V.A.C.® GRANUFOAM™ dressing available from Kinetic Concepts, Inc. of San Antonio, Texas. In other embodiments, the optional foam 140 may be any other porous material configured to withstand the application of reduced-pressure to the chamber 102.

In some embodiments, the test model 100 may further include the visual indicator 106. The visual indicator 106 may be configured to provide a visual state change in response to deformation of the tissue simulation material 104. For example, the visual indicator 106 may be or may include, without limitation, one or more of the following: a cut or cast shape, a slit, a hole, an aperture, a colored portion or color contrast, spaced fibers or markers, and/or an array of sensors positioned on the tissue simulation material 104. The visual indicator 106 may be visually perceived from an exterior of the chamber 102 because the chamber 102 is comprised of a transparent material. In general, the tissue simulation material 104 may deform or lift in response to exposing the second surface 136 of the tissue simulation material 104 to a reduced pressure. The deformation or lifting of the tissue simulation material 104 may model tissue distension at a tissue site when the tissue site is exposed to a reduced-pressure. For example, the visual state change may be observable when the second surface 136 of the tissue simulation material 104 is exposed to a lower pressure than the first surface 134 of the tissue simulation material 104.

The visual state change may include one or more of a change in size, a change in shape, a change in position, a change in color, or a change in contrast of any of the aforementioned examples of the visual indicator 106. For example, a hole, slit, or aperture may provide a visual stage change as an increase in size and/or a change in shape when the tissue simulation material 104 is exposed to reduced-pressure as described herein. Further, a colored portion on the tissue simulation material 104 can change shade or contrast to provide a visual state change. Further, fibers, sensors, or other markers may provide a change in position that can be perceived or mapped to provide a visual state change. Provided below are specific, non-limiting exemplary examples of visual indicators 106 and visual state changes that can be used with different embodiments of the test model 100. Other embodiments may use different visual indicators 106 that are configured to allow a visual state change to be visually perceived.

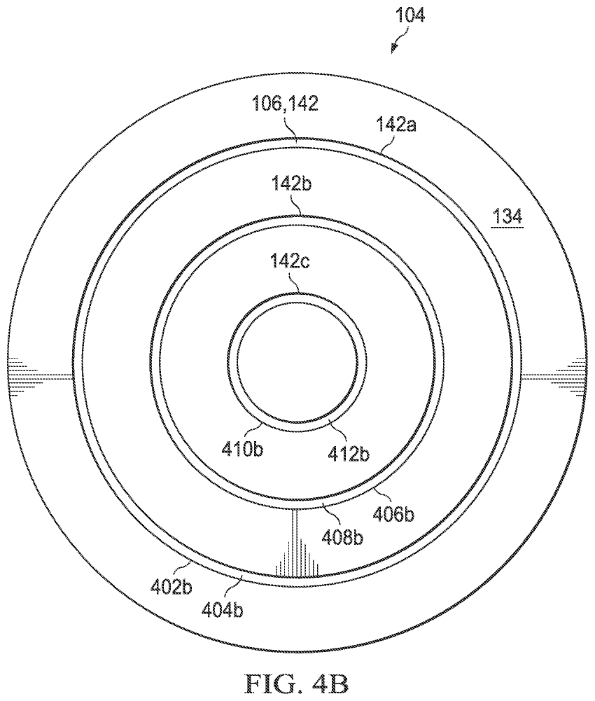

In some embodiments, the visual indicator 106 may be a plurality of concentric circles 142 formed integrally with the tissue simulation material 104. For example, the plurality of concentric circles 142 may be partial thickness cast, cut, slit, molded, or formed into the first surface 134 of the tissue simulation material 104. In other embodiments, the plurality of concentric circles 142 may be coupled to the first surface 134 of the tissue simulation material 104. The plurality of concentric circles 142 may be coupled to the first surface 134 of the tissue simulation material 104 by a weld, adhesives, or any other suitable means of coupling. In a resting state, when the tissue simulation material 104 is at atmospheric pressure, each circle 142 of the plurality of concentric circles 142 may have a first circumference and a first line thickness as shown in FIG. 4A. When the second surface 136 of the tissue simulation material 104 is exposed to the reduced-pressure, each circle 142 of the plurality of concentric circles 142 may have a second circumference and a second line thickness as shown in FIG. 4B. Each second circumference and second line thickness may be larger than the first circumference and the first line thickness. The visual state change may be in increase in circumference and/or an increase in a line thickness or size of the concentric circles 142 when the second surface 136 of the tissue simulation material 104 is exposed to the reduced-pressure. Although a plurality of concentric circles 142 are illustrated in the accompanying figures, any suitable continuous, discontinuous, concentric, or non-concentric shape may be suitable.

Referring to FIGS. 4A and 4B, the tissue simulation material 104 may have a first circle 142a, a second circle 142b, and a third circle 142c. FIG. 4A may show the tissue simulation material 104 when the second surface 136 is exposed to atmospheric pressure and the tissue simulation material 104 is in a resting state free of deformation. When the second surface 136 is exposed to atmospheric pressure, the first circle 142a may have a circumference 402a and a line thickness 404a, the second circle 142b may have a circumference 406a and a line thickness 408a, and the third circle 142c may have a circumference 410a and a line thickness 412a. FIG. 4B shows the tissue simulation material 104 after the second surface 136 has been exposed to reduced-pressure and the tissue simulation material 104 is in a deformed state. When the second surface 136 is exposed to reduced-pressure, the first circle 142a may have a circumference 402b and a line thickness 404b, the second circle 142b may have a circumference 406b and a line thickness 408b, and the third circle 142c may have a circumference 410b and a line thickness 412b. Circumference 402b may be larger than circumference 402a, line thickness 404b may be larger than line thickness 404a, circumference 406b may be larger than circumference 406a, line thickness 408b may be larger than line thickness 408a, circumference 410b may be larger than circumference 410a, and line thickness 412b may be larger than line thickness 412a. The visual state change may be the difference between the first circle 142a, the second circle 142b, and the third circle 142c between FIG. 4A and FIG. 4B. For example, the visual state change may be the change in the first circle 142a from circumference 402a and line thickness 404a to circumference 402b and line thickness 404b, the change in the second circle 142b from circumference 406a and line thickness 408a to circumference 406b and line thickness 408b, and the change in the third circle 142c from circumference 410a and line thickness 412a to circumference 410b and line thickness 412b.

In other embodiments, the plurality of concentric circles 142 may be formed integrally with the lid 110 in a similar manner as described for the tissue simulation material 104. For example, the plurality of concentric circles 142 may be etched into the exterior surface 120 of the lid 110 of the chamber 102. In some embodiments, the plurality of concentric circles 142 may be etched into the interior surface 118 of the lid 110 of the chamber 102. In other embodiments, the plurality of concentric circles 142 may be coupled to the exterior surface 120 or the interior surface 118 of the lid 110. The plurality of concentric circles 142 may be coupled to the exterior surface 120 or the interior surface 118 of the lid 110 by a weld, adhesives, or any other suitable means of coupling. In such embodiments, each circle 142 of the plurality of circles 142 may have a stationary position and shape relative to the chamber 102, permitting a user to visually perceive movement of the tissue simulation material 104 relative to the plurality of concentric circles 142 within the chamber 102. For example, when the second surface 136 of the tissue simulation material 104 is exposed to the reduced-pressure, the lifting or deformation effect on the tissue simulation material 104 may be perceived as a change in shape or movement of the tissue simulation material 104 relative to each circle 142 of the plurality of concentric circles 142.

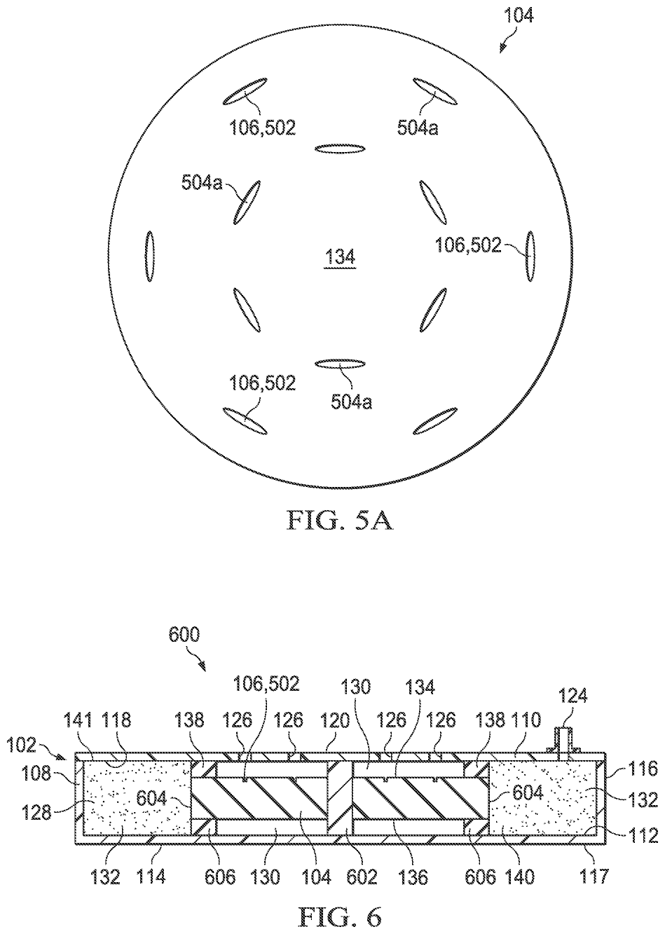

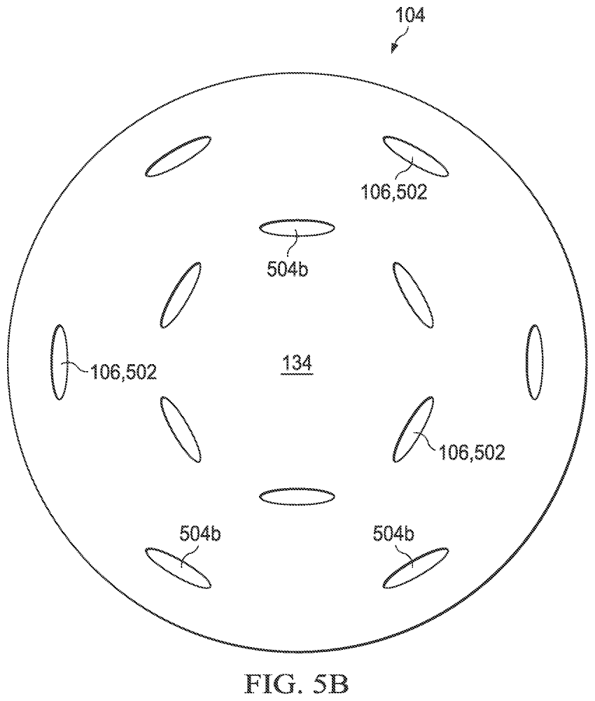

Referring to FIGS. 5A and 5B, some example embodiments of the test model 100 may include the visual indicator 106 as a plurality of holes or slits 502 disposed in the tissue simulation material 104. FIG. 5A shows the tissue simulation material 104 when the second surface 136 is exposed to atmospheric pressure and the tissue simulation material 104 is in a resting state free of deformation. When the second surface 136 is exposed to atmospheric pressure, the plurality of slits 502 may be in a resting state and each slit 502 of the plurality of slits 502 may have a first width 504a. FIG. 5B shows the tissue simulation material 104 after the second surface 136 has been exposed to reduced-pressure and the tissue simulation material 104 is in a deformed state. When the second surface 136 is exposed to reduced-pressure, the plurality of slits 502 may be in a deformed state and each slit 502 of the plurality of slits 502 may have a second width 504b. The second width 504b may be larger than the first width 504a for each slit 502 of the plurality of slits 502. The visual state change may be the change from the first width 504a of the plurality of slits 502 of FIG. 5A to the second width 504b of the plurality of slits 502 of FIG. 5B.

FIG. 6 illustrates an example embodiment of a cross section of a test model 600. The test model 600 may include the base 108 and the lid 110 of the chamber 102 as described above with reference to FIGS. 1-3. In some embodiments, the lid 110 of the chamber may include a plurality of atmospheric ports 126 to allow the first surface 134 of the tissue simulation material to be fluidly coupled to the ambient environment.

The test model 600 may include the tissue simulation material 104 and the visual indicator 106 as described above with reference to FIGS. 5A and 5B. In some embodiments, there may be an axel 602 included in the test model 600. The axel 602 may extend from the lid 110 to the base 108 of the chamber 102 to help maintain the central alignment of the tissue simulation material 104 within the test model 600. In some embodiments, the axel 602 may extend through the tissue simulation material 104. The first surface 134 of the tissue simulation material 104 may be located proximate to the lid 110. The second surface 136 of the tissue simulation material 104 may be located proximate to the base 108 of the chamber 102. The tissue simulation material 104 may have a wall or a third surface 604 that extends from the first surface 134 to the second surface 136.

In some embodiments, the test model 600 may further include the chamber seal 138 as described above in FIGS. 1-3. The chamber seal 138 may be coupled to the first surface 134 of the tissue simulation material 104 and may extend from the first surface 134 of the tissue simulation material 104 to the interior surface 118 of the lid 110 of the chamber 102. In some embodiments, there may be a second chamber seal 606 that may be coupled to the second surface 136 of the tissue simulation material 104. The second chamber seal 606 may be substantially the same as the chamber seal 138. The second chamber seal 606 may extend from the second surface 136 of the tissue simulation material 104 to the interior surface 112 of the base 108 of the chamber 102. In other embodiments, the second chamber seal 606 may not be included in the test model 600 because the second surface 136 of the tissue simulation material 104 may extend to the interior surface 112 of the base 108 of the chamber 102.

The interior volume 128 of the chamber 102 may be divided into the first portion 130 and the second portion 132 similar to FIGS. 1-3. In some embodiments, the tissue simulation material 104 may be positioned within the first portion 130 of the interior volume 128 of the chamber 102. The optional foam 140 may be disposed within the second portion 132 of the interior volume 128 of the chamber 102 and may be adjacent to the third surface 604 of the tissue simulation material 104. The chamber seal 138 may fluidly isolate the first portion 130 and the first surface 134 of the tissue simulation material 104 from the second portion 132 of the interior volume 128. The second chamber seal 606 may fluidly isolate the first portion 130 and the second surface 136 of the tissue simulation material 104 from the second portion 132 of the interior volume 128. The reduced-pressure port 124 may be configured to provide reduced-pressure to the second portion 132 of the interior volume 128. The third surface 604 of the tissue simulation material 104 may be exposed to reduced-pressure when the test model 600 is connected to a reduced-pressure source. The third surface 604 of the tissue simulation material 104 may be exposed to a lower pressure than the first surface 134 and the second surface 136 of the tissue simulation material 104 when reduced-pressure is applied to the test model 600. The difference in pressure between the third surface 604 and the first surface 134 and the second surface 136 may allow the tissue simulation material 104 to deform as shown in FIGS. 5A and 5B.

In other example embodiments, the visual indicator 106 could be included on both the first surface 134 and the second surface 136 of the tissue simulation material 104 to provide a further visual aid to observers of the effects of circumferential negative pressure. In still other embodiments, there may be a first tissue simulation material and a second tissue simulation material included in the chamber 102. Each of the first tissue simulation material and the second tissue simulation material may be substantially the same as the tissue simulation material 104 described above. The first of the tissue simulation material 104 could be disposed proximate to the lid 110 of the chamber 102 and the second of the tissue simulation material 104 could be disposed proximate to the base 108 of the chamber 102. The first of the tissue simulation material 104 and the second of the tissue simulation material 104 could be separated and held in place within the chamber 102 with the axel 602. The first of the tissue simulation material 104 and the second of the tissue simulation material 104 may each have the first surface 134 that may be exposed to atmospheric pressure and may each have the second surface 136 that may be exposed to reduced-pressure. There may be other configurations not described herein that may be similar to those described above which expose a first surface and a second surface of the tissue simulation material 104 to differential pressures such that the tissue simulation material 104 can deform in response to the difference in pressure.

In some example embodiments such as FIGS. 5A, 5B, and 6, the chamber seal 138, the second chamber seal 606, and the plurality of slits 502 may be formed or manufactured from a silicone of higher durometer than the silicone used to make the silicone disk of the tissue simulation material 104. The higher durometer silicone used for the plurality of slits 502 may prevent tearing of the plurality of slits 502 during the application of reduced-pressure. The higher durometer silicone used for the chamber seal 138 and the second chamber seal 606 may ensure that the first portion 130 of the interior volume 128 of the chamber 102 is fluidly sealed from the second portion 132 of the interior volume 128 of the chamber. In some embodiments, the use of a higher durometer silicone may allow pigment to be added to the plurality of slits 502. Using pigment in the plurality of slits 502 may allow an observer to more easily visually perceive the visual state change during the application of reduced-pressure. In some embodiments, the silicone disk may be the silicone disk as described above with a durometer of between about Shore 00-00 and Shore 00-20. In some preferred embodiments, the silicone disk may have a durometer of about Shore 00-10. The chamber seal 138, the second chamber seal 606, and each slit 502 of the plurality of slits 502 may be comprised of a silicone of a durometer of between about Shore A-00 and Shore A-20. In some preferred embodiments, the chamber seal 138, the second chamber seal 606, and each slit 502 of the plurality of slits may be comprised of a silicone with a durometer of about Shore A-12.

In embodiments in which the visual indicator 106 may be a fiber, at least one fiber may be coupled to the tissue simulation material 104. In some embodiments, the at least one fiber may be embedded in the tissue simulation material 104. In other embodiments, the at least one fiber may be coupled to the tissue simulation material 104 by a weld, an adhesive, or another suitable method. In a resting state, when the second surface 136 of the tissue simulation material 104 is at atmospheric pressure, the at least one fiber may be located at a first distance from a defined location on the chamber 102. For example, the at least one fiber may be located a first distance from the atmospheric port 126 of the lid 110. When the second surface 136 of the tissue simulation material 104 is exposed to the reduced-pressure, each fiber may be located at a second distance from the defined location on the chamber 102. For example, when the second surface 136 of the tissue simulation material 104 is exposed to the reduced-pressure, the at least one fiber may be located at a second distance from the atmospheric port 126 of the lid 110. The second distance may be longer than the first distance. The visual state change may be a change in the distance or position of the at least one fiber relative to the atmospheric port 126 or another fiber or any other reference feature when the second surface 136 of the tissue simulation material 104 is exposed to the reduced-pressure.

In other embodiments, the visual indicator 106 may be at least one object located on the first surface 134 of the tissue simulation material 104. In some embodiments, the at least one object may be a bead or another similar object that can roll or move easily when the first surface 134 is deformed from the application of reduced-pressure to the second surface 136 of the tissue simulation material 104. In a resting state, when the second surface 136 of the tissue simulation material 104 is at atmospheric pressure, the at least one object may be located at a first point on the first surface 134 of the tissue simulation material 104. When the second surface 136 of the tissue simulation material 104 is exposed to the reduced-pressure, the at least one object may move to a second point on the first surface 134 of the tissue simulation material 104. The first point may be different from the second point. The visual state change may be a change in the position of the at least one object on the first surface 134 of the tissue simulation material 104 when the second surface 136 of the tissue simulation material 104 is exposed to the reduced-pressure.

In other embodiments, the visual indicator 106 may be at least one colored area of the tissue simulation material 104. The at least one colored area of the tissue simulation material 104 may be created by dyeing or adding color in any suitable manner to at least one portion of the tissue simulation material 104 such that the at least one colored area of the tissue simulation material 104 is a different color than the remainder of the tissue simulation material 104. In a resting state, when the second surface 136 of the tissue simulation material 104 is at atmospheric pressure, the at least one colored area may appear as a first tone or a first shade. When the second surface 136 of the tissue simulation material 104 is exposed to the reduced-pressure, the at least one colored area may appear as a second tone or a second shade. The visual state change may be the contrast between the first tone or the first shade and the second tone or the second shade of the at least one colored area when the second surface 136 of the tissue simulation material 104 is exposed to the reduced-pressure. In a specific example, a color border positioned around a circumference or perimeter of one or more of the slits 502 in the embodiments of FIGS. 5A-5B may show a color contrast when the slits 502 are deformed.

With any of the above mentioned visual indicators 106, comparative imaging may be used to more clearly capture the visual state change. For example, a camera may be used to capture at least one image of the test model 100 before the application of reduced-pressure. The camera may further capture images of the test model 100 during the application of reduced-pressure and after the application of the reduced-pressure. The images may show the visual state change of the test model throughout the application of the reduced-pressure. These images may allow a user to better explain the visual state change as a result of the application of reduced-pressure and specifically the application of circumferential reduced-pressure to the tissue simulation material 104.

In other embodiments, the visual indicator 106 may be an array of sensors distributed throughout the tissue simulation material 104 and/or throughout the chamber 102. The array of sensors may be configured to sense or to track any movement of the tissue simulation material 104 during the application of reduced-pressure to the chamber 102. The array of sensors may be communicatively coupled to a computer or other user interface. The computer or user interface may convert the data from the array of sensors into a format suitable for communicating the movement or deformation of the tissue simulation material 104 during the application of reduced-pressure to the chamber 102.

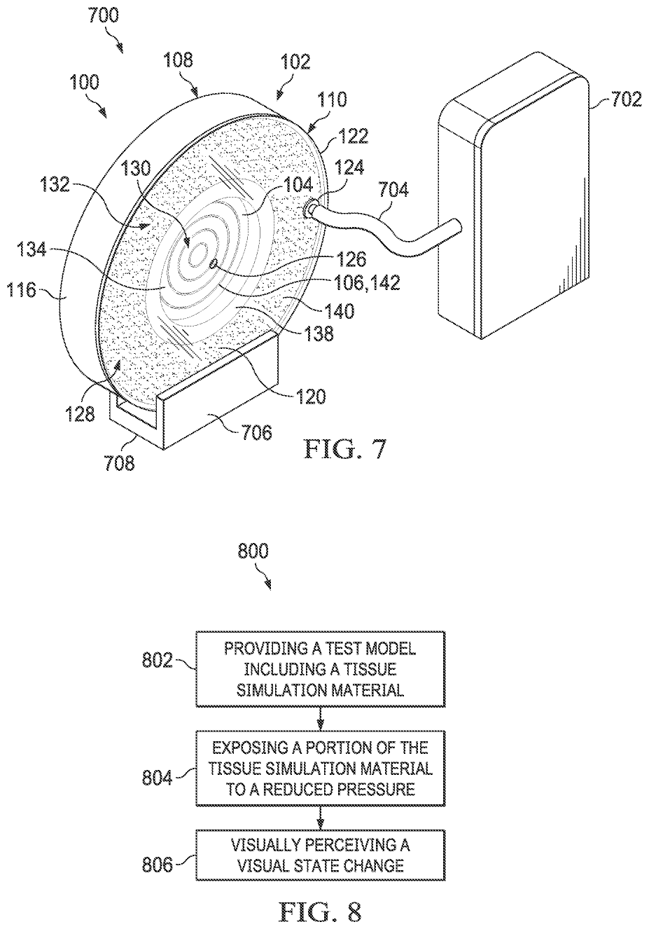

Referring to FIG. 7, a system 700 for demonstrating the effects of circumferential negative pressure is shown. The system 700 may include the test model 100 and a reduced-pressure source 702. The test model 100 may include the chamber 102, the tissue simulation material 104, and the visual indicator 106 as shown in FIGS. 1-3. The chamber 102 may be fluidly connected to the reduced-pressure source 702 through a conduit 704. The reduced-pressure source 702 may be configured to generate a reduced-pressure in the second portion 132 of the interior volume 128 of the chamber 102. The application of reduced-pressure to the second portion 132 of the interior volume 128 of the chamber 102 may demonstrate the application of circumferential negative pressure to a tissue site. The reduced-pressure source 702 may be any suitable device for providing reduced-pressure, such as, for example, a vacuum pump, wall suction, hand pump, or another source.

As used herein, “reduced-pressure” generally refers to a pressure less than the ambient pressure at the first portion 130 of the interior volume 128 of the chamber 102. Typically, this reduced-pressure will be less than the atmospheric pressure. The reduced-pressure may also be less than a hydrostatic pressure at the first portion 130 of the interior volume 128 of the chamber 102. Unless otherwise indicated, values of pressure stated herein are gauge pressures. While the amount and nature of reduced-pressure applied to the second portion 132 of the interior volume 128 of the chamber 102 will typically vary according to the application, the reduced pressure will typically be between −5 mm Hg and −500 mm Hg, and more typically in a therapeutic range between −100 mm Hg and −200 mm Hg.

The reduced-pressure delivered may be constant or varied (patterned or random), and may be delivered continuously or intermittently. Although the terms “vacuum” and “negative pressure” may be used to describe the pressure applied to the tissue site, the actual pressure applied to the second portion 132 of the interior volume 128 of the chamber 102 may be more than the pressure normally associated with a complete vacuum. Consistent with the use herein, an increase in reduced-pressure or vacuum pressure typically refers to a relative reduction in absolute pressure. An increase in reduced-pressure corresponds to a reduction in pressure (more negative relative to ambient pressure) and a decrease in reduced-pressure corresponds to an increase in pressure (less negative relative to ambient pressure).

The test model 100 may further include a display stand 706. The display stand 706 may be configured to receive the chamber 102 such that the lid 110 of the chamber 102 may be perpendicular to a bottom surface 708 of the display stand 706. In other embodiments, the display stand 706 may receive a different portion of the chamber 102. The chamber 102 may be disposed in the display stand 706 during application of reduced-pressure to the second surface 136 of the tissue simulation material 104. Disposing the chamber 102 in the display stand 706 may provide an easier way for a user to visually perceive the visual state change that occurs during the application of reduced-pressure to the second portion 132 of the interior volume 128 of the chamber 102.

Referring primarily to FIG. 8 and to features previously described in FIGS. 1-3, a method 800 of demonstrating tissue distension is shown. In other embodiments, the method may include additional, fewer, and/or different steps. Providing the test model 100 including the tissue simulation material 104 may be a first step 802. The test model 100 may include the chamber 102 that may include the interior volume 128. The tissue simulation material 104 may be disposed within the interior volume 128.

The method may further include exposing a portion of the tissue simulation material 104 to a reduced-pressure in step 804. For example, in some embodiments, the first surface 134 of the tissue simulation material 104 may be exposed to atmospheric pressure and the second surface 136 of the tissue simulation material 104 may be exposed to reduced-pressure. In some embodiments, the first surface 134 of the tissue simulation material 104 may be exposed to atmospheric pressure through the atmospheric port 126. The second surface 136 of the tissue simulation material 104 may be exposed to the reduced-pressure through the reduced-pressure port 124.

The method may further include visually perceiving a visual state change in step 806. The visual state change may be visually perceived when the second surface 136 of the tissue simulation material 104 is exposed to reduced-pressure. The visual state change may be one or more of a change in size, a change in shape, a change in position, or a change in color. For example, in some embodiments, the plurality of concentric circles 142 may be cast into the first surface 134 of the tissue simulation material 104. Each circle 142 of the plurality of concentric circles 142 may have a first circumference prior to exposing the portion of the test model to the reduced-pressure. Each circle 142 of the plurality of concentric circles 142 may have a second circumference after exposing the portion of the second surface 136 of the tissue simulation material 104 to the reduced-pressure. Each second circumference may be larger than the corresponding first circumference. Visually perceiving the visual state change may help an observer understand what changes occur to the tissue simulation material 104 when the second surface 136 of the tissue simulation material 104 is exposed to the reduced pressure.

Other methods for demonstrating tissue distension using the test model 100 are provided. In some examples, the method may include providing the chamber 102. The chamber 102 may include the base 108, the lid 110, and the interior volume 128 defined between the base 108 and the lid 110. The method may further include disposing the tissue simulation material 104 within the interior volume 128 of the chamber 102. The tissue simulation material 104 may include the first surface 134 and the second surface 136 positioned opposite the first surface 134. The tissue simulation material 104 can be configured to deform when the second surface 136 is exposed to a lower pressure than the first surface 134 in the interior volume 128 of the chamber 102.

In some examples, the method may further include coupling the reduced-pressure port 124 of the chamber 102 to the reduced-pressure source 702. The method may then include activating the reduced-pressure source 702 to expose the second surface 136 of the tissue simulation material 104 to a lower pressure than the first surface 134 within the interior volume 128 of the chamber 102. The method may further include visually perceiving the visual indicator 106 configured to provide a visual state change in response to deformation of the tissue simulation material 104.

The systems, apparatuses, and methods described herein may provide significant advantages. For example, the test model 100 may communicate the effects of circumferential negative pressure through a visual demonstration. Because the chamber 102 of the test model 100 may be transparent, any lifting or deformation of the tissue simulation material 104 during the application of reduced-pressure from the reduced-pressure source 702 may be easily observed. The test model 100 may allow an observer to visually perceive a simulated impact of the application of reduced-pressure to a tissue site.

While shown in a few illustrative embodiments, a person having ordinary skill in the art will recognize that the systems, apparatuses, and methods described herein are susceptible to various changes and modifications that fall within the scope of the appended claims. Moreover, descriptions of various alternatives using terms such as “or” do not require mutual exclusivity unless clearly required by the context, and the indefinite articles “a” or “an” do not limit the subject to a single instance unless clearly required by the context. Components may be also be combined or eliminated in various configurations for purposes of sale, manufacture, assembly, or use. For example, in some configurations the tissue simulation material 104, the chamber 102, or both may be eliminated or separated from other components for manufacture or sale. In other example configurations, the reduced-pressure source 702 may also be manufactured, configured, assembled, or sold independently of other components.

The appended claims set forth novel and inventive aspects of the subject matter described above, but the claims may also encompass additional subject matter not specifically recited in detail. For example, certain features, elements, or aspects may be omitted from the claims if not necessary to distinguish the novel and inventive features from what is already known to a person having ordinary skill in the art. Features, elements, and aspects described in the context of some embodiments may also be omitted, combined, or replaced by alternative features serving the same, equivalent, or similar purpose without departing from the scope of the invention defined by the appended claims.

1. A test model comprising:
a chamber comprising a base, a lid, and an interior volume defined between the base and the lid;
a tissue simulation material disposed in the interior volume of the chamber, wherein the tissue simulation material includes a first surface and a second surface, and wherein the tissue simulation material is configured to deform when the second surface is exposed to a lower pressure than the first surface in the interior volume of the chamber; and
a visual indicator configured to provide a visual state change in response to deformation of the tissue simulation material.

2. The test model of claim 1, wherein the chamber is formed from a transparent material, and wherein the visual indicator can be visually perceived from an exterior of the chamber through the transparent material.

3. The test model of claim 1, wherein the tissue simulation material is gas impermeable and elastic.

4. The test model of claim 1, wherein the tissue simulation material is positioned between a first portion of the interior volume of the chamber and a second portion of the interior volume of the chamber, wherein the first surface of the tissue simulation material is exposed to the first portion and the second surface of the tissue simulation material is exposed to the second portion, and wherein the first portion is fluidly isolated from the second portion.

5. The test model of claim 4, wherein the second portion of the interior volume of the chamber extends from the base to the lid and surrounds the first portion of the interior volume of the chamber.

6. The test model of claim 4, further comprising a chamber seal configured to extend from the first surface of the tissue simulation material to the lid of the chamber and to fluidly seal the first portion of the interior volume from the second portion of the interior volume within the chamber, wherein the first portion of the interior volume is defined between the first surface of the tissue simulation material and the lid of the chamber.

7. The test model of claim 4, wherein the second portion of the interior volume of the chamber is configured to be fluidly coupled to a reduced-pressure source through a reduced-pressure port in the chamber.

8. The test model of claim 4, wherein the first portion of the interior volume of the chamber is configured to be in fluid communication with ambient atmospheric pressure through an atmospheric port in the chamber.

9. The test model of claim 4, further comprising foam disposed in the second portion of the interior volume of the chamber.

10. The test model of claim 1, wherein the visual indicator is configured to provide the visual state change in response to the second surface of the tissue simulation material being exposed to the lower pressure.

11. The test model of claim 1, wherein the visual state change includes one or more of a change in size, a change in shape, a change in position, or a change in color.

12. The test model of claim 1, wherein the tissue simulation material comprises a silicone disk.

13. The test model of claim 1, wherein the tissue simulation material comprises a flexible membrane.

14. The test model of claim 1, wherein the visual indicator comprises at least one circle cast into the tissue simulation material.

15. The test model of claim 1, wherein the visual indicator comprises at least one circle etched into the lid of the chamber.

16. The test model of claim 1, wherein the visual indicator comprises at least one slit or at least one hole or both the at least one slit and the at least one hole in the tissue simulation material.

17. The test model of claim 1, wherein the visual indicator comprises at least one fiber embedded into the tissue simulation material.

18. The test model of claim 1, wherein the visual indicator comprises at least one colored area of the tissue simulation material.

19. A method of demonstrating tissue distension, the method comprising:
providing a chamber comprising a base, a lid, and an interior volume defined between the base and the lid;
disposing a tissue simulation material within the interior volume of the chamber, the tissue simulation material comprising a first surface and a second surface, and wherein the tissue simulation material is configured to deform when the second surface is exposed to a lower pressure than the first surface in the interior volume of the chamber;
coupling a reduced-pressure port of the chamber to a reduced-pressure source;
activating the reduced-pressure source to expose the second surface of the tissue simulation material to a lower pressure than the first surface within the interior volume of the chamber; and
visually perceiving a visual indicator configured to provide a visual state change in response to deformation of the tissue simulation material.

20. A method of demonstrating tissue distension, the method comprising:
providing a chamber including an interior volume and a tissue simulation material disposed within the interior volume;
exposing a first surface of the tissue simulation material to atmospheric pressure and a second surface of the tissue simulation material to a reduced-pressure; and
visually perceiving a visual state change when the second surface is exposed to the reduced-pressure.

21. (canceled)
